(19) United States
(12) Patent Application Publication
(10) Pub. No.: US 2007/0006840 A1
(43) Pub. Date: Jan. 11, 2007

(54) Operating apparatus for controlling a vibratory rammer

(75) Inventor: Gunnar Hedlund, Karlskrona (SE)

Correspondence Address: WALTER OTTESEN, PO BOX 4026, GAITHERSBURG, MD, 20885-4026, US

(73) Assignee: Dynapac Compaction Equipment AB

(21) Appl. No.: 11/475,949

(22) Filed: Jun. 28, 2006

(30) Foreign Application Priority Data
Jul. 6, 2005 (SE) 0501569-8

(51) Int. Cl. F02D 37/02

(52) U.S. Cl. 123/198 DB; 123/198 DC

(57) ABSTRACT

An operating apparatus (1) controls working revolutions of a vibratory rammer. The operating apparatus (1) includes an operating lever (4) movable between an idle position (2) and a stop position (3) and an engine switch-off function (5) and a fuel shut-off function (6). The engine switch-off function (5) and fuel shut-off function (6) are actuated with the operating lever (4) to be inactive in the idle position (2) or activated in the stop position (3). The engine switch-off function (5) is activated before the fuel shut-off function (6) is activated when the operating lever (4) is moved from the idle position (2) to the stop position (3). The activation ceases in reverse order when the operating lever (4) is moved from the stop position (3) to the idle position (2).

### CROSS REFERENCE TO RELATED APPLICATION

This application claims priority of Swedish patent application no. 0501569-8, filed Jul. 6, 2005, the entire content of which is incorporated herein by reference.

### FIELD OF THE INVENTION

This invention refers to an operating apparatus for controlling the working revolutions of a vibratory rammer and for actuating a number of functions, such as fuel shut-off and engine switch-off. The invention is suitable for use on vibratory rammers that have an internal combustion engine with an ignition system and a fuel valve for fuel shut-off.

The operating apparatus and method ensure that the combustion engine is not shut down due to a restriction of the fuel supply.

### BACKGROUND OF THE INVENTION

U.S. Pat. No. 6,419,420 is incorporated herein by reference and discloses an operating apparatus which can be actuated by an operator to control the aforementioned functions. The functions are combined and allocated to three main lever positions. These three lever positions are made “fixed” by the lever being affected by attraction forces when it is in the vicinity of these positions. During normal, expected operation, the operator moves the lever into one of the “fixed” positions.

In the “stop position” of the operating apparatus, the fuel shut-off and engine switch-off functions are activated. The fuel supply is shut off via a fuel valve, the closing of which is initiated when the lever is moved from an “idle position” towards a “stop position”. When the valve is fully closed, the engine switch-off function is activated just before the “stop position” is reached. The engine switch-off function contains an electric switch that short circuits the ignition system of the engine. The sequence of events is locked to the method and is of minor importance during normal operation. This is because it takes less than one second to move the lever from the “idle position” to the “stop position”.

During abnormal operation, there is a risk that the operator will hold or leave the operating lever in a “non-fixed” position between the “idle position” and the “stop position”, where the fuel valve is closed but the engine switch-off function has not been activated. This results in the internal combustion engine shutting down once the fuel in the fuel lines and carburetor has been consumed.

This phenomenon is mentioned in U.S. Pat. No. 5,720,250, but is described as a possible result of a conscious operation to create the condition.

In practice, the internal combustion engine has proven to be difficult to start when the fuel valve reopens (through a reverse process) to start the engine. This is because many start attempts are necessary to refill the fuel lines and carburetor with fuel.

### SUMMARY OF THE INVENTION

It is an object of the invention to provide an operating device and a method wherein the aforementioned phenomenon cannot occur. In the method and with the operating apparatus of the invention, it is ensured that the engine switch-off function is activated before the fuel shut-off function is activated when the operating apparatus is operated towards and to the “stop position”. The operating apparatus is designed to actuate the functions following a course of events that corresponds to the method. The functions are positioned in a sequence that either matches or does not match the course of events. The latter is made possible by a flexible stop in accordance with an embodiment of the invention.

### BRIEF DESCRIPTION OF THE DRAWINGS

The invention will now be described with reference to the drawings wherein:

FIG. 1 is a schematic showing the method of the invention in the context of a first embodiment of an operating apparatus according to the invention shown in a side view;

FIG. 2 shows the method and a second embodiment of an operating apparatus according to the invention shown in side view with this embodiment incorporating a flexible stop; and,

FIG. 3 shows another embodiment of a flexible stop in a slightly enlarged view.

### DESCRIPTION OF THE PREFERRED EMBODIMENTS OF THE INVENTION

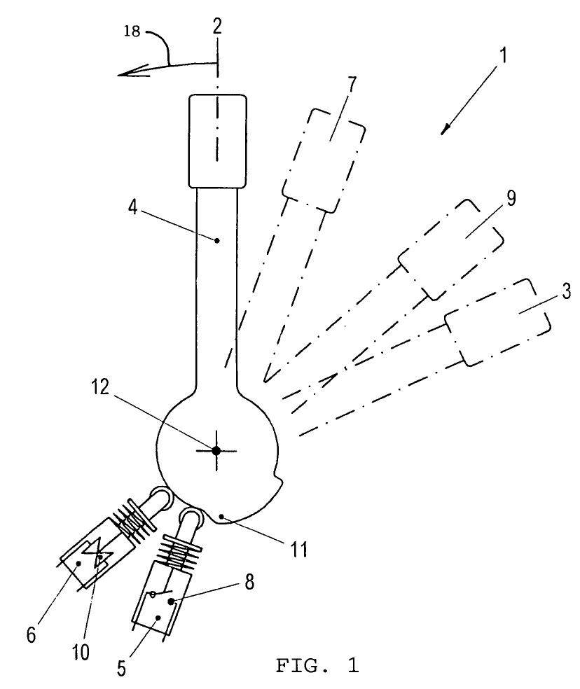

FIG. 1 shows an operating apparatus 1 for controlling the operating speed of a vibratory rammer including bringing the vibratory rammer to an idle position 2 or a stop position 3. The operating apparatus 1 comprises an operating lever 4, an engine switch-off function 5 and a fuel shut-off function 6. The operating apparatus 1 should be positioned so that its operating lever 4 is easily accessible to the person operating the rammer. It is best to position the operating lever on the control handle of the vibratory rammer or at another location near where the operator grips the handle as shown in U.S. Pat. No. 6,419,420.

The functions (5, 6) are actuable with the operating lever 4 via a cam mechanism 11. It is also possible to use mechanisms with grooves to obtain, for example, a sequential actuation. It is also possible to electronically detect the position of the operating lever and actuate the functions via electrical or magnetic pulses.

The operating lever 4 is shown in a position that corresponds to the idle position 2. The functions (5, 6) are inactive in this position which means that the engine switch-off function 5 is actuated to be in a state wherein ignition pulses are obtained from the ignition system of the internal combustion engine and the fuel shut-off function 6 is actuated in a state wherein fuel can pass through the function. In the idle position 2, the vibratory rammer is inoperative. The operator selects the idle position during short work breaks or when starting the rammer.

The working revolutions of the vibratory rammer increase when the operating lever 4 is moved from the idle position 2 in the direction of the arrow 18. The engine switch-off and fuel shut-off functions (5, 6) are inactive during this operation. It is advantageous to configure the operating apparatus 1 so that the movement of the lever 4 is stopped at an end position in which the ideal working revolutions are obtained and to define this condition as an “operating position”.

Working revolutions are dependent on engine speed. The operating apparatus can be configured so that it can be actuated by the operating lever 4 via a control cable, wiring, hydraulics or a servo.

When the operating lever 4 is moved from the idle position 2 in the opposite direction and towards the stop position 3, it first reaches an engine switch-off position 7 at which the engine switch-off function 5 is activated. This means that the engine switch-off function 5 is actuated to a condition wherein ignition pulses cannot be obtained from the ignition system of the engine. The engine switch-off function 5 preferably comprises an electric switch 8 that short circuits the ignition system or disconnects the same.

The lever 4 then reaches the fuel shut-off position 9 at which the fuel shut-off function 6 is activated. This means that the fuel shut-off function 6 is actuated to a condition wherein the fuel cannot pass the function. Preferably, the fuel shut-off function 6 comprises a valve 10 that acts in the fuel line between the fuel tank and the engine.

Finally, the lever 4 reaches the stop position 3 whereat both functions (5, 6) are activated. The operator selects this stopped condition to switch off the vibratory rammer for longer breaks or when the work is complete and the machine is to be transported away.

It is advantageous to make the idle position 2, stop position 3 and “operating position” easy for the operator to find by making them fixed. This is achieved by configuring the operating apparatus 1 so that the operating lever 4 is affected by attraction forces in these positions. The strength of the attraction forces must be adapted so that the force the operator must apply to overcome them automatically means transfer to the adjacent fixed position. This makes it possible to ensure that the operator only moves the operating lever to the fixed positions during normal operation. During abnormal operation, that is when the operator moves the operating lever 4 to a position between the fixed positions (2, 3) and leaves it there, it is ensured that the engine is not shut down due to restriction of the fuel supply.

The functions (5, 6) are positioned around fulcrum 12 of the operating lever 4 in a sequence that matches the sequence in which they are activated. The direction of the sequence is defined by the rotary motion of the lever 4 when operated from the idle position 2 to the stop position 3.

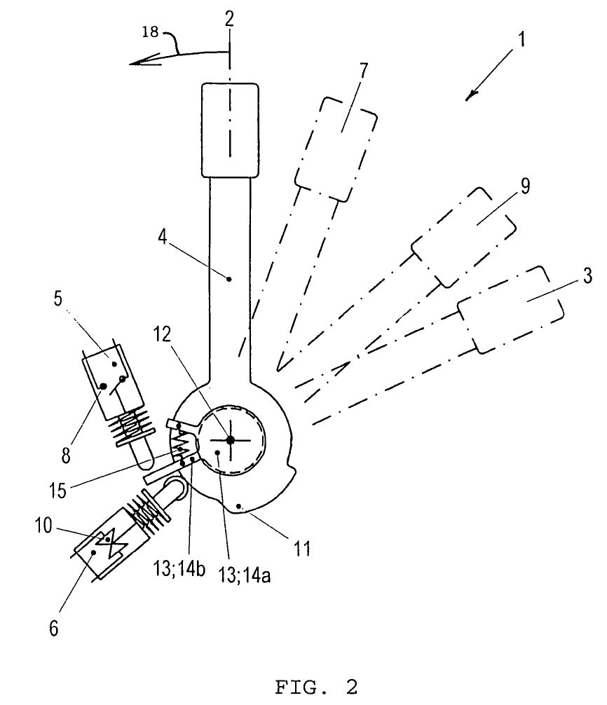

FIG. 2 shows a second embodiment of the operating apparatus 1 of the invention. The operating lever 4 is operated to the same positions and modes indicated in FIG. 1. The functions in this embodiment are the same as in FIG. 1. The description for FIG. 1 can therefore also be applied to FIG. 2 and differences between the two embodiments will now be explained.

The engine switch-off function 5 is actuated via a flexible stop 13. This flexible stop comprises two discs (14a, 14b), which are pivotally mounted at the fulcrum 12 of the operating lever 4, and a spring 15 which acts around the fulcrum 12. The two discs (14a, 14b) are mutually connected by the spring 15. The spring 15 is a tension spring, but it is possible to use torsion springs, spiral springs or an elastic material.

One disc 14a is fixedly connected to the operating lever 4 so as to pivot therewith and the disc 14b is freely rotatable about fulcrum 12. The rotary motion of disc 14a, which results from lever operation, is transferred to the second disc 14b via the spring 15. The properties of the spring 15 are adapted so that it is possible to transfer the rotary movement to the second disc 14b and thus activate the engine switch-off function 5. A further rotary movement of the disc 14b is thus prevented by the abutment against the engine switch-off function 5. The disc 14a, however, continues to follow the rotary motion of the operating lever 4 by expansion of the spring 15.

This makes it possible to position the functions (5, 6) around the fulcrum 12 of the operating lever 4 at locations that do not match the sequence in which they are activated. This option can be utilized when there is insufficient space to position the functions in a logical order. This solution is helpful when the space for placing components is at a premium.

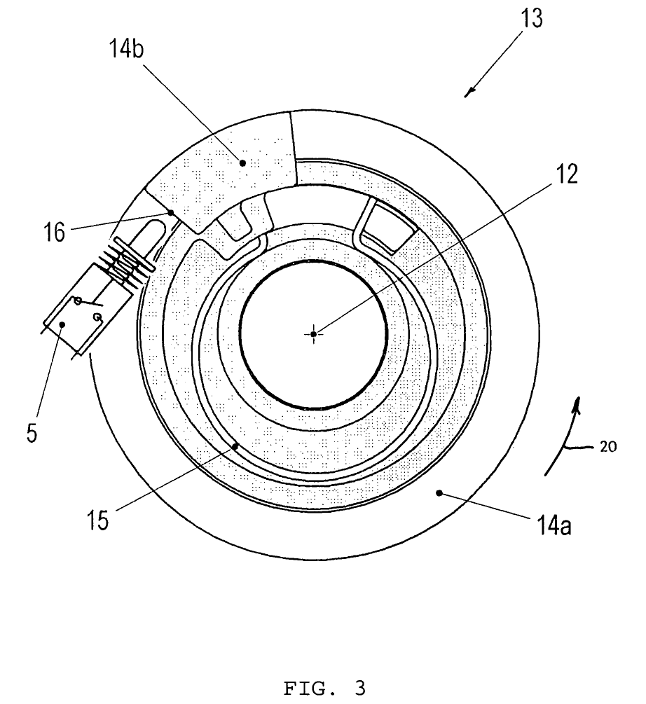

FIG. 3 shows a preferred embodiment of a flexible stop 13. The operating principle is the same as for the flexible stop in FIG. 2. Here, the mechanism is shown from the rear so that disc 14a, which is fixedly attached to the operating lever 4, rotates in the direction of arrow 20 when the lever 4 is moved from the idle position 2 to the stop position 3 shown in FIG. 2.

The description for FIG. 2, regarding the function of the flexible stop 13, can therefore be used with respect to FIG. 3. The flexible stop 13 comprises two discs (14a, 14b), which are pivotally mounted at the fulcrum 12 of the operating lever 4, and a spring 15 which acts around the fulcrum 12. The disc 14a is connected to the operating lever 4 and follows its movement as noted above. The two discs (14a, 14b) are mutually connected by the spring 15 which is a torsion spring. The motion for the spring that is described in FIG. 2 is replaced by a twisting motion. The disc 14b has a stop lip 16 which actuates the engine switch-off function 5 upon contact.

The operating apparatus of the invention can be integrated into a fuel tank of a vibratory rammer similar to the design in the previously mentioned U.S. Pat. No. 6,419,420.

The operating apparatus of the invention can be configured to also actuate closing of fuel tank ventilation. This embodiment is to be adapted so that the engine switch-off function and fuel shut-off function are activated before tank ventilation is closed during an operation in which the operating apparatus is actuated to assume the “stop position”.

It is understood that the foregoing description is that of the preferred embodiments of the invention and that various changes and modifications may be made thereto without departing from the spirit and scope of the invention as defined in the appended claims.

What is claimed is:

1. A method for operating an operating apparatus for controlling the working revolutions of a vibratory rammer including an internal combustion engine having an ignition system, the operating apparatus including: an operating lever movable along a path between an idle position and a stop position of the vibratory rammer; an engine switch-off function switchable between a first position wherein the ignition system of said engine is connected so that pulses can be transmitted from the ignition system and a second position wherein the connection to said ignition system is interrupted so that no pulses can be transmitted from the ignition system; a fuel shut-off function switchable between a first position wherein fuel can flow to said engine and a second position wherein the flow of fuel to said engine is interrupted; and, said engine switch-off function and said fuel shut-off function being disposed along said path; the method comprising the step of moving said operating lever from said idle position to said stop position so as to cause said operating lever to first act on said engine switch-off function to switch said switch-off function into said second position and thereafter act on said fuel shut-off function to switch said fuel shut-off function into said second position as said operating lever is moved from said idle position toward said stop position.

2. The method of claim 1 including the further step of moving said operating lever back from said stop position to said idle position to sequentially switch said fuel shut-off function and said engine switch-off function back into said first positions, respectively, in reverse order as said operating lever is moved from said stop position back to said idle position.

3. An operating apparatus for controlling the working revolutions of a vibratory rammer including an internal combustion engine having an ignition system and said operating apparatus comprising:
an operating lever movable along a path between an idle position and a stop position of the vibratory rammer;
an engine switch-off function switchable between a first position wherein the ignition system of said engine is connected so that pulses can be transmitted from the ignition system and a second position wherein the connection to said ignition system is interrupted so that no pulses can be transmitted from the ignition system;
a fuel shut-off function switchable between a first position wherein fuel can flow to said engine and a second position wherein the flow of fuel to said engine is interrupted; and,
said engine switch-off function and said fuel shut-off function being disposed along said path so as to cause said operating lever to first act on said engine switch-off function to switch said switch-off function into said second position and thereafter act on said fuel shut-off function to switch said fuel shut-off function into said second position as said operating lever is moved from said idle position toward said stop position and to sequentially switch said fuel shut-off function and said engine switch-off function back into said first positions, respectively, in reverse order as said operating lever is moved from said stop position back to said idle position.

4. The operating apparatus of claim 3, wherein said fuel shut-off function includes a valve for interrupting said flow of fuel.

5. The operating apparatus of claim 3, wherein said engine switch-off function includes an electric switch for interrupting the flow of pulses from the ignition system to said engine.

6. The operating apparatus of claim 3, wherein said operating lever is pivotally connected at a fulcrum and said engine switch-off function and said fuel shut-off function are positioned on said path around said fulcrum so that they are sequentially switched into the corresponding ones of said second positions as said operating lever is pivoted about said fulcrum from said idle position to said stop position.

7. The operating apparatus of claim 3, wherein said operating lever is pivotally connected at a fulcrum and said engine switch-off function and said fuel shut-off function are positioned on said path around said fulcrum so that they are sequentially switched into the corresponding ones of said second positions as said operating lever is pivoted about said fulcrum from said idle position to said stop position; and, flexible stop means for actuating said engine switch-off function into said second position thereof in a manner disproportionate to the angular movement of said operating lever about said fulcrum as said operating lever is moved from said idle position into said stop position.

8. The operating apparatus of claim 7, wherein said flexible stop means comprises a first disc connected to said operating lever so as to rotate therewith; a second disc rotatably mounted at said fulcrum so as to be rotatable relative to said first disc and said operating lever; a resilient member interconnecting said first and second discs so as to permit said second disc to follow said first disc; and, said second disc including means for striking said engine switch-off function for switching said engine switch-off function into said second position as said operating lever is pivoted from said idle position to said stop position.

9. The operating apparatus of claim 8, wherein said resilient member is a spring.
